(19) United States
(12) Patent Application Publication
(10) Pub. No.: US 2013/0206116 A1
(43) Pub. Date: Aug. 15, 2013

(54) METHOD FOR ADJUSTING A CHARGE PRESSURE IN AN INTERNAL COMBUSTION ENGINE HAVING A PRESSURE-WAVE SUPERCHARGER

(71) Applicants: Jillis Legrom, LJ Eindhoven (NL); Theo Van Den Munckhof, CW Deurne (NL); Fabian Fricke, Paderborn (DE)

(72) Inventors: Jillis Legrom, LJ Eindhoven (NL); Theo Van Den Munckhof, CW Deurne (NL); Fabian Fricke, Paderborn (DE)

(73) Assignee: Benteler Automobiltechnik GmbH, 33102 Paderborn (DE)

(21) Appl. No.: 13/578,945

(22) PCT Filed: Feb. 17, 2011
(86) PCT No.: PCT/DE2011/000144

§ 371 Date: Sep. 11, 2012

(30) Foreign Application Priority Data
Feb. 17, 2010 (DE) 10 2010 008 385.2

(51) Int. Cl. F02B 37/00

(52) U.S. Cl. CPC F02B 37/00
USPC 123/559.1

(57) ABSTRACT

A method for adjusting charge pressure of a combustion engine is disclosed, wherein the charge pressure is built up by a pressure-wave supercharger to which a channel 1 for drawing in fresh air, a channel 2 for discharging compressed fresh air, a channel 3 for supplying exhaust gas, and a channel 4 for discharging exhaust gas are connected and which includes a cold-gas housing, to which channels 1 and 2 are connected, a gas pocket valve arranged in the area of channel 3, and a circulating-air valve connecting channel 2 to channel 3. A control disk for adjusting the pressure-wave process by a geometric offset of channel 3-4 to channel 1-2 is arranged in the housing and charge pressure is controlled according to a control disk position and/or a gas pocket valve position and/or a rotor speed of the pressure-wave supercharger and/or a circulating-air valve position.

The present invention relates to a method for adjusting a charge pressure of a combustion engine, with the charge pressure being built-up by a pressure-wave supercharger, in accordance with patent claim 1.

To increase power output, combustion engines use structural parts which are suitable to compress aspirated fresh air and to feed it subsequently to the combustion process. These machines are designated as charge systems and use various compressor types to carry out the afore-mentioned process.

One possibility to charge the combustion engine through compression of the aspirated fresh air involves the use of a pressure-wave supercharger. The efficiency of these pressure-wave superchargers is determined by the mechanical components and the possibility to adaptively suit the respective operating state of the engine in the form of a closed-loop control and open-loop control.

The pressure-wave supercharger is assembled from fixed and rotating components. The fixed components involve: the housing jacket, the rotor housing which is split into a hot-case housing and cold-gas housing, and the feed lines and discharge lines for guiding the gaseous fluid. The rotating components are formed by the rotor itself and optionally by an electric motor for operating the rotor.

DE 10 2006 020 522 A1 discloses a method of operating an internal combustion engine, whereby fresh air is compressed by a pressure-wave supercharger and at least one operating parameter of the pressure-wave supercharger is controlled or regulated as a function of at least one actual operating variable of the internal combustion engine. The method disclosed therein represents a departure from the current rigid and substantially noncontrolled or nonregulated operating concepts of pressure-wave superchargers.

The adjustment of the operation of the pressure-wave supercharger to the actual operating state of the internal combustion engine minimizes pumping losses of the internal combustion engine. The responsiveness of the pressure-wave supercharger can also be improved in this manner, and the conditions for an exhaust gas aftertreatment can be optimized. A housing offset is a possibility as an operating parameter of the pressure-wave supercharger that is to be controlled or regulated.

The large-scale use of a pressure-wave supercharger, for example on a combustion engine in the automotive field, has to meet high demands with respect to operating conditions and life expectancy. It is, for example, conceivable in this context to require the pressure-wave supercharger to reliably function at −20° C. and at +50° C. outside temperature and over a life cycle of several years. Also exhaust-gas temperatures of 900° C. and higher adversely affect the longevity and the reliable function of the pressure-wave supercharger.

Pressure-wave superchargers known from the state of the art have the drawback that the control of the pressure-wave supercharger is established in response to a housing offset. To provide a robust housing offset that is also suitable for mass production is not economically viable heretofore using currently known production methods, in particular against the backdrop that slight gap dimensions must be maintained between the rotating and fixed components of the pressure-wave conductor so as to ensure high efficiency of the pressure-wave supercharger.

The state of the art further discloses conventional regulation and control methods for pressure-wave superchargers using a multiplicity of sensors which again incur a high costs for mass production and are highly prone to fail. The use of redundant sensor systems would lead to even greater costs.

As a result of pressure differences between intake tract and exhaust tract, a gas-dynamic process forms in the rotor cells of the pressure-wave supercharger. A detailed modeling of a pressure-wave supercharger that could be implemented on a control device is not possible with current CAx methods (for example CAE, CFD, BEM).

It is therefore an object of the present invention to provide a method for control and regulation of a pressure-wave supercharger to optimize emission behavior, response behavior, durability, and efficiency of the pressure-wave supercharger and at the same time to enable mass production which is substantially independent from external influences.

The afore-stated object is solved with a method having the features of patent claim 1.

Advantageous refinements are the subject matter of the dependent patent claims.

The method according to the invention for adjusting a charge pressure of a combustion engine, with the charge pressure being built up by a pressure-wave supercharger and with a channel 1 for drawing in fresh air, a channel 2 for discharging the compressed fresh air, a channel 3 for supplying exhaust gas, and a channel 4 for discharging exhaust gas being connected to the pressure-wave supercharger, and the pressure-wave supercharger having a cold-gas housing, to which channel 1 and channel 2 are connected, a gas pocket valve, which is arranged in the area of channel 3, and a circulating-air valve, which connects the channel 2 to the channel 3, is characterized in that a control disk for adjusting the pressure-wave process by means of a geometric offset of channel 3-4 to channel 1-2 is arranged in the cold-gas housing and the charge pressure is adjusted an/or controlled is dependence on a control disk position and/or a gas pocket valve position and/or a rotor speed of the pressure-wave supercharger and/or a circulating-air valve position. Within the scope of the invention, individual operating parameters can be controlled and at the same time other ones, e.g. the circulating-air valve control, can be adjusted.

As alternative to the control through the circulating-air valve position, a variable valve control time of the intake valves and/or discharge valves can be utilized to scavenge air into the exhaust system upstream of the pressure-wave supercharger to trigger a secondary reaction with simultaneous temperature rise.

The method according to the invention has the advantage of a control which can be realized cost-efficiently in the mass production for control and regulation of pressure-wave superchargers on combustion engines. The method according to the invention enables the pressure-wave supercharger to consume less energy compared to the state of the art. The virtual real-time adjustment of the operating variables of the pressure-wave supercharger to the respective operating state of the combustion engine thus causes little power loss by the pressure-wave supercharger itself. An increase of the efficiency of the pressure-wave supercharger is accompanied by an increase of the efficiency of the combustion engine.

Control disk position is to be understood as the adjustment of the control disk which is arranged in the cold-gas housing and has openings dispersed across its area and which interconnects on the one side the feed opening of the aspirated fresh air or the discharge line of the compressed fresh air and on the other side the rotor cell inlet zones. The duration of the pressure wave acting on the gaseous fluid being compressed is determined in dependence on the position of the control disk. As a result, there is an offset between channel 1-2 and channel 3-4.

This is directly beneficial on the adjusting gas-dynamic effect of the pressure-wave supercharger. The control disk, in turn, is hereby operated again via a control disk slide-valve motor. This involves an electric actuator which is able to quickly and rapidly turn the adjustment of the control disk. According to a preferred embodiment, the control disk position is implemented in dependence on at least one of the following operating parameters: engine rotation speed, engine temperature, charge-air temperature, actual intake-air temperature value, ambient-air pressure, exhaust-gas temperature, desired charge air value, actual charger pressure value, desired operation point.

The ambient-air pressure but also the ambient temperature can be used within the scope of the invention for control of the control disk position. The engine temperature may hereby involve a temperature tap, for example in the engine block housing, at the engine oil, or at the cooling water, or the like, so that existing sensors may be used. The required operating variable of the engine temperature for control disk position from the engine temperature picked up by the sensors may be calculated on the basis of a computer model inside of a control device. This has the advantage of being able to make use of already existing sensors. This renders mass production cost-effective, in particular with respect to a motor vehicle.

Furthermore, the exhaust-gas temperature can be ascertained within the scope of the invention by a combined lambda sensor temperature exhaust-gas measurement. In this way, the need for additional sensors in the exhaust-gas region can again be eliminated. It is, however, conceivable to measure the exhaust-gas temperature in the exhaust-gas outlet between the outlet valve and inlet via the channel 3 in the pressure-wave supercharger or after exiting the pressure-wave supercharger in channel 4 or in a following exhaust-gas tract or manifold. It is, however, also conceivable within the scope of the invention to determine the exhaust-gas temperature on the basis of an exhaust-gas temperature model. This does not involve a determination by sensors.

The desired charge air value can be determined within the scope of the invention using a computer model in dependence on the operating point in a respective characteristic diagram of the combustion engine and thus predefined. The desired charge air value may also be directly read out from the engine control device or made available by the engine control device. The actual charge air value is hereby a value which can be measured sensorily in the channel 2 upstream of the throttle valve or before entering the combustion chamber. It is also conceivable within the scope of the invention to provide the combustion engine with a charge-air cooler between compressed air and entry into the cylinder. As a result, the pressure state of the charge-air changes so that the charge pressure can be converted into the desired operating variable by using a computer model. It is also conceivable within the scope of the invention to use a computer model for determining the actual charge-air value. For example, the respectively required charge pressure can be ascertained using the ideal gas law in the form of a temperature measurement and/or further variables, for example air mass meter or pressure sensor.

The desired operation point is the desired operating point in a characteristic diagram of the combustion engine. The desired operating point can again be determined for example on the basis of the engine speed and the accelerator pedal position of a motor vehicle. It is also conceivable within the scope of the invention to directly determine the desired operation point from the engine control device. Preferably, this involves a value which is determined as a function of the accelerator pedal position. It is, however, also conceivable within the scope of the invention to infer or read out the desired operation point directly from a control device, using torque-based load recognition.

According to a further preferred variant of embodiment, the control disk position is established in dependence on the difference of desired charge air value and actual charge-air value.

Regulating and controlling the control disk position in dependence on the difference of the two charge-air values affords the possibility to reduce or build-up the actual charge pressure value in a particularly rapid manner. The desired charge pressure value can, for example, be determined within the scope of the invention by using a computer model.

According to a further preferred embodiment, the control disk position is adjusted in dependence on the temperature and/or the thermodynamic state of the fresh air in channel 1, the rotor speed and/or the pressure-wave supercharger geometry. The respectively adjusting and expected local speed of sound is predominantly determined within the scope of the invention in dependence on the temperature and the thermodynamic state of the fresh air. This, however, cannot be achieved by measurement and is therefore ascertained using computer models which are inferred from the ideal gas law as well as flow-mechanical formulae for determination of velocities.

For example, it is possible to calculate the localized speed or sound in the cells using the state in channel 1 before entry into the rotor cell via the thermodynamic equation of state, the velocity as function of the gas constant, the temperature exponents and the isentropic exponent. Further influences, illustrated for example, by the heating of the cell, require a correction of the calculated value of the localized sound of speed in the rotor cell because no measurement of the temperature and/or gas composition is possible in the rotor cell. According to most simple embodiment, the rotor speed may hereby be directly tapped from the rotor motor which primarily involves an electric motor.

Pressure-wave supercharger geometry is to be understood within the scope of the invention as relating to state variables of the installation space as derived from the mechanical components. The latter oar defined, for example, by length, width, height of the pressure-wave supercharger housing, volumes of the rotor cells or also by the respective inlet and outlet openings of the channels 1 to 4. Furthermore, pressure-wave supercharger geometry is also to be understood as relating to dynamic state variables. These may involve, for example, flow angle or inflow angle. The inflow angles are established as a result of the adjustment of the control disk position or of various valves, such as throttle valve for example. It may, however, also involve a bypass opening in the form of the circulating-air valve or also flow about a charge-air cooler for example. The complexity of the computer mode of the geometric pressure-wave supercharger dimensions depends on the achievable precision of the operating state, being adjusted, of the pressure-wave supercharger. The flow into the rotor cells themselves is dependent on the pressure-wave supercharger geometry but also on the fixed geometry of the channels in the housing.

According to a further preferred variant of embodiment, the scavenging air amount of channel 1 to channel 4 is regulated by the setting of the control disk position. It is hereby possible to flush in dependence on the desired operating state a great amount of fresh air from the inlet of channel 1 directly into channel 4 so that little residual gas mixture remains in the rotor cell. In an operating state of partial load, it may be advantageous to again add a certain proportion of residual gas to the combustion. To reduce exhaust-gas emission, it is, however, advantageous to add a certain proportion of residual gas to the combustion so as to promote a decrease in nitrogen oxides.

According to another especially preferred variant of embodiment, the scavenger air amount from channel 1 to channel 4 is adjusted during a cold start by the control disk position. This may cause, depending on the desired operating state in cold-start performance of the combustion engine, a high exhaust-gas recirculation or also a high flushing rate. This adjustment is significantly influenced by the outside temperature. During cold-start performance, the exhaust-gas temperature in the channel 3 is, however, the critical variable which can be influenced for example by the control disk position and/or gas pocket valve position and/or rotor speed and/or circulating-air valve position and therefore again affects the charge pressure.

According to another preferred variant of embodiment, an overflow of exhaust gas from channel 3 to channel 2 in the fresh air zone is prevented by the control disk position in dependence on at least one of the following operating parameters: the actual charge-air temperature value, the desired operation point, engine speed, intake-air temperature, exhaust-gas temperature.

The objective during operation of the combustion engine is to substantially prevent the breakthrough of exhaust gas from channel 3 to channel 2. An overflow of the exhaust gas in the channel 2 causes an increase of the charge-air temperature so that the volume of the charge air rises, which can be used in partial load operation to improve efficiency by unthrottling. It should however be considered here that recirculation of an excessive amount of exhaust gas can cause misfiring.

According to another preferred embodiment, the gas pocket valve position is set in dependence on at least one of the following operating parameter: engine speed, engine temperature, exhaust-gas temperature, actual charge pressure value, desired charge pressure value, ambient air pressure.

The gas pocket valve seats in channel 3 in close proximity upstream of the inlet of exhaust gas discharged from the combustion tract into the pressure-wave supercharger. With the assistance of the gas pocket valve, the inlet openings for the exhaust gas can be enlarged on the hot-gas housing side. The gas pocket valve itself is hereby controlled by a gas pocket valve actuator. The gas pocket valve enables a control of part of the exhaust mass flow so as to prevent it from participation in the compression. This actuator may again involve an electric actuator which enables a particularly quick reaction of the desired adjustment of the gas pocket valve. The control or regulation of the position of the gas pocket valve determines the compression performance and improves in particular the response behavior of the internal combustion engine. An undesired breakthrough of exhaust gas from channel 3 to channel 2 and the accompanying recirculation of exhaust gas to the combustion process can be avoided by the control and regulation of the gas pocket valve in combination with the control disk position.

According to an especially preferred embodiment, the difference between desired charge pressure value and actual charge pressure value for adjusting the gas pocket valve position is used. A controller can hereby be applied for example in the form of a P, I or PID controller or the like to compensate overshoot. The controller controls hereby any deviations encountered during the actual operation between desired value and actual value of the charge pressure. Overcompensation as a result of the deviations is therefore prevented.

According to a further preferred embodiment of the present invention, the rotor speed is adjusted in dependence on the engine speed and/or the actual charge pressure value. The rotor speed is hereby a crucial factor influencing the charge cycle within the pressure-wave supercharger. The rotor speed is predefined by an electric motor which actively drives the pressure-wave supercharger rotor.

Particularly preferred is a compensation of load oscillations during idling of the combustion engine by adjusting the gas pocket valve position and/or control disk position. In this way, a substantially constant rotor speed is maintained, thereby preventing the presence of positive or also negative accelerations of the rotor.

This is particularly advantageous for the expected acoustic effects on one hand, and by avoiding acceleration of the rotor saves energy to a greatest possible extent on the other hand, thereby again advantageously affecting the efficiency of the pressure wave supercharger. The adjustment of the gas pocket valve or also the control disk can be realized by the respectively corresponding actuators in a particularly rapid and efficient manner. This results in a rapid adaptation to the respective operating state of the internal combustion engine, which in turn leads to an increase in the efficiency.

According to a further particularly preferred embodiment of the present invention, load oscillations during idling of the combustion engine are compensated by briefly shutting down a consumer. Consumer within the scope of the invention relate, for example, to an air-conditioning compressor, a vehicle heater, or also a power steering compressor, a water pump, a heated rear window, or similar components.

Current combustion engines adjust the idle speed as low as possible to save fuel. In turbocharged engines having small displacement, it is difficult to maintain the engine idle speed constant so that in a worst-case scenario an undesirable engine shutdown can be encountered when consumers are turned on and/or off.

Starting may also be problematic when the ambient air pressure and ambient air temperature are low and all consumers are turned on. This phenomenon occurs especially at low-displacement engines in heavy-duty vehicles which are equipped with numerous electrical consumers. In order to keep power consumption of the pressure-wave supercharger during idling and also in a range near the idling area as low as possible, control manipulations are to be compensated via the rotor motor by switching off the consumers.

In the event an adjustment via the rotor speed is required in addition to a control and regulation via the control disk position or gas pocket valve position, it is possible within the scope of the invention to briefly shutdown a consumer so as to liberate an electric energy portion which can be diverted to the control and regulation of the electric rotor motor. As a result, an idle load oscillation is suppressed. Load oscillations relate within the scope of the invention to oscillations which are generated by mechanical loads, for example those transmitted via the drive train, or also electrical loads, for example, as a result of positive acceleration of the rotor motor, which represents an electrical load oscillation in the form of an electric additional consumption.

According to a further variant of embodiment of the present invention, load oscillations are compensated during operation of the combustion engine at substantially constant operating point by adjusting the gas pocket valve position and/or control disk position. A substantially constant operating point relates within the scope of the invention to a point in an combustion engine characteristic map which is determined by a substantially constant engine speed and a substantially constant load. This operating point exits in actual use, however, only for a very short period of time in the millisecond range so that a regulation and control can be realized with the method according to the invention virtually in real time and with rapid response time. During operation of the combustion engine, a consumer can be turned off to also compensate load oscillations.

According to a further preferred variant of embodiment of the present invention, the load oscillations are compensated during operation of the combustion engine at substantially constant operating point by optimally adjusting the rotor speed. This affords the possibility to adjust the operating point of the pressure-wave supercharger to the present operating point of the combustion engine by adjusting the rotor speed. In combination with the gas pocket valve position and/or the control disk position for compensation of load oscillations during operation of the combustion engine, this variant is a good alternative, or also affords the possibility of a redundant system in the event of a defect of one of the afore-mentioned adjustment options.

It is also conceivable within the scope of the invention to switch off an electrical consumer during a change in rotor speed to compensate the electrical load oscillation.

According a further embodiment of the present invention, a circulating-air valve position is adjusted in dependence on at least one of the following operating parameters: the actual charge pressure value, desired charge pressure value, engine temperature, exhaust gas temperature, engine speed, desired operating point. A circulating-air valve relates to a valve which connects the channel 2 with the channel 3. The circulating-air valve affords the possibility to feed compressed air in the intake tract directly to the exhaust gas tract. This results in a bypass function which excludes both the charge-air cooler and the combustion engine in the circulation between intake air and exhaust gas. This has the particular positive effect on the possibility to achieve a rapid pressure increase in channel 3 and on an exhaust gas temperature increase due to afterburning in a catalytic converter.

This system is able to attain a substantial improvement of the starting behavior of the pressure-wave supercharger. As an alternative, these parameters can be controlled through use of variable valve timing of intake valve and discharge valve. This achieves an identical effect and the circulating-air valve may be omitted. This saves additional costs when used in large scale production.

Further advantages, features, characteristics and aspects of the present invention will become apparent from the following description. Preferred embodiments are shown in schematic drawings which are provided for ease of understanding of the invention. It is shown in:

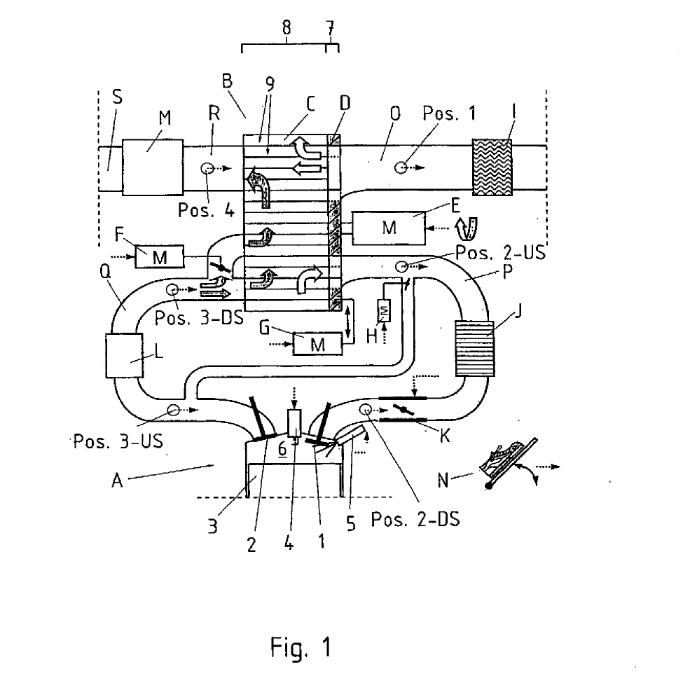

FIG. 1 a basic illustration of the circulation of intake air across the combustion engine up to the exhaust-gas discharge, and

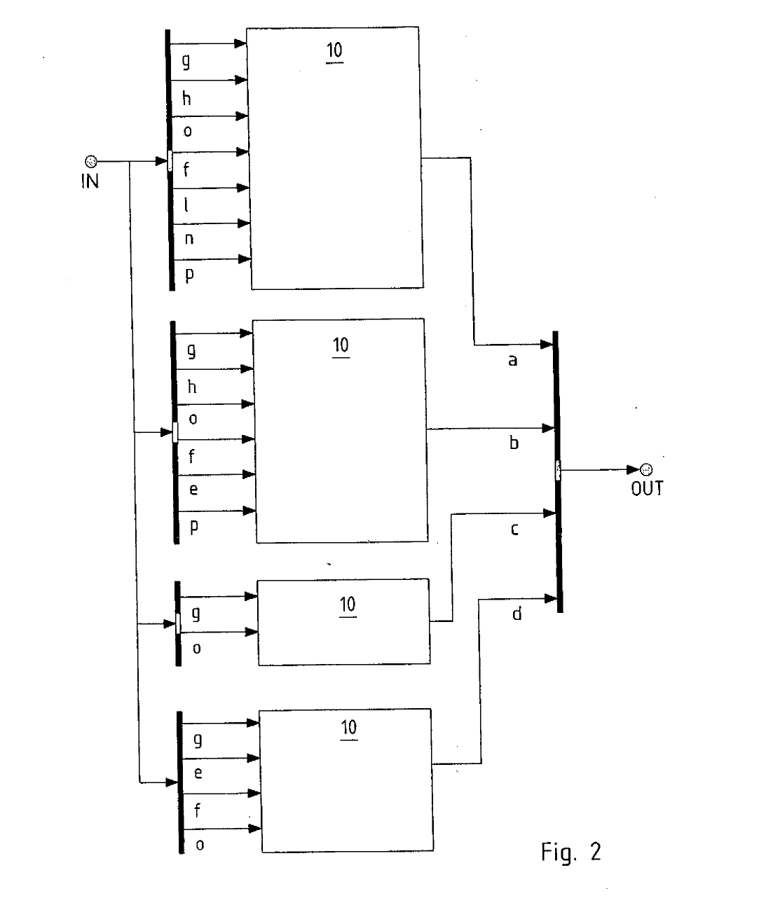

FIG. 2 a flow diagram for regulation and control of set variables.

In the figures same reference signs are used for same or similar parts, wherein corresponding or similar advantages are achieved even if a repeated description is omitted for sake of simplicity.

FIG. 1 shows a part-section of an embodiment of a combustion engine A in the form of an Otto engine. Illustrated here is a sectional view through the cylinder, with an inlet valve 1, an outlet valve 2, a piston 3, a spark plug 4, an injection nozzle 5, and a combustion chamber 6. Connected to the internal combustion engine A is a pressure-wave supercharger B. The pressure-wave supercharger B in turn has four channels (O, P, Q, R) which are connected thereto. These involve the channel 1 (O) in the area of aspirated fresh air, the channel 2 (P) in the region of the compressed fresh air for delivery to a charge-air cooler J, and an adjoining throttle valve K from which the compressed fresh air is fed to the combustion chamber 6. Further provided are a channel 3 (Q) which is arranged downstream of the outlet valve 2, and a catalytic converter upstream of the pressure-wave supercharger B to introduce the exhaust gas into the pressure-wave supercharger B. Also disposed in the channel 3 (Q) is a gas pocket valve with a gas pocket valve actuator F. In the area of the exhaust tract S, the pressure-wave supercharger B includes the channel 4 (R) for discharge of exhaust after the compression process in the pressure-wave supercharger B. The channel 4 (R) also has an oxidation catalytic converter M.

The pressure-wave supercharger B further includes a cold-gas housing side 7 and a hot-gas housing side 8. Arranged in the cold-gas housing half 7 is a control disk. The control disk is controlled by a control disk actuator. The rotor C arranged in the pressure-wave supercharger B is operated by an electric rotor motor E.

The aspirated fresh air follows a path through the channel 1 (O) into the rotor cell 9 respectively situated adjacent the channel 1 (O) and is compressed in the pressure-wave supercharger B. The compressed air is then fed in the outlet zone of the channel 2 (P) via the channel 2 (P) to the inlet valve 1. A circulating-air valve with associated actuator H is interposed here in channel 2 (P) to circumvent the charge-air cooler and the combustion chamber 6 via a bypass line. The compressed and heated air is cooled in the charge-air cooler J to thereby reduce its volume, resulting in a higher filling degree of the cylinder in the combustion chamber 6.

It follows the intake cycle, followed by the compression cycle, the combustion cycle and the exhaust cycle, using as the four-stroke engine as the example. The use for a differently cycled engine is, however, also conceivable within the scope of the invention.

In the exhaust cycle, the exhaust gas formed in the combustion chamber 6, is fed through the channel 3 (Q) to the pressure-wave supercharger B again to the hot-gas side. An interposed catalytic converter L executes hereby a first exhaust-gas aftertreatment. Also arranged in the channel 3 (Q) is the gas pocket valve F, which is driven by a gas pocket valve actuator F and enables an increased entry of residual gas in the rotor cells 9 via the inlet opening of the channel 3 (Q) and guides exhaust gas past the rotor leads directly into channel 4 (R). It is also possible within the scope of the invention to route the exhaust gas directly via the gas pocket valve from channel 3 (Q) into channel 4 (R).

The pressure wave compresses the fresh air aspirated through the channel 1 fresh air and ensures that the compressed fresh air flows into the channel 2 (P), and is then transferred through the outlet opening of the rotor cells at channel 4(R) to the exhaust tract. The exhaust gas then flows through optional further exhaust gas aftertreatment components, for example in the form of an oxidation catalytic converter M.

FIG. 1 further depicts measurement points which represent potential taps of the required operating variables. Position 1 shows a tap of measurement data in the intake region of fresh air. Pos. 2 US shows a tap of measurement data in the region of the compressed fresh air upstream of the charge-air cooler J. Pos. 2 DS shows a tap downstream of the throttle valve K just shy of the inlet valve 1 of the combustion engine A. Pos. 3 US shows a possible tap point in the channel 3 (Q). Pos. 3 DS shows a measuring point in the channel 3 (Q) upstream of an entry into the pressure-wave supercharger B. The pos. 3 US and 3 DS are each selected in such a way as to measure the total flow downstream and upstream of the circulating-air valve F or gas pocket valve H so as to provide measurement data for a circulating-air valve position or gas pocket valve position b.

Pos. 4 shows a possible measuring point in the exhaust tract S downstream of the pressure-wave supercharger B. The measuring positions shown here have proven advantageous within the scope of the invention, however, may be supplemented or reduced depending on the application at hand by further measuring positions and their local position may also be placed freely selectable.

FIG. 2 shows a block diagram for adjusting a charge pressure. Data are here supplied via a data bus system on the left-hand side of the drawing plane via the point IN. This data are fed on the right-hand side of the drawing plane based in a point OUT again to a data bus. The operating parameters required for a method according to the invention can be respectively tapped on the data bus. The block diagram shown here is implemented for example on a control device.

The evaluating and computer module 10 depicted uppermost in the drawing plane determines the control disk position a is determined. For that purpose, desired charge pressure value g, actual charge pressure value h, engine speed o, exhaust gas temperature f, actual charge-air temperature value l, actual intake air temperature value n, and the ambient air pressure p are read from the data bus. The evaluating and computer module 10 then determines the desired control disk position using a method according to the invention and outputs it again to a data bus. The output may, however, also take place directly to the control disk actuator.

A further evaluating and computer module 10 determines the rotor speed gas pocket valve position b. For that purpose, desired charge pressure value g, actual charge pressure value h, engine speed o, exhaust gas temperature f, engine temperature e, and ambient air pressure p are fed into the evaluating and computer module 10. Using at least one of the operating variables, the desired gas pocket valve position is determined and outputted again to a data bus system or also directly to the gas pocket valve actuator F.

A further evaluating and computer module 10 determines the rotor speed c of the pressure-wave supercharger B. For that purpose, desired charge pressure value g and engine speed o are evaluated from the data bus. An output to a data bus or a direct operation of the evaluating and computer module 10 of the rotor motor E may also take place here.

A further evaluating and computer module 10 determines the desired circulating-air valve position d. For that purpose, desired charge pressure value g, engine temperature e, exhaust temperature f as well as engine speed o are evaluated. The desired circulating-air valve position is again output to a bus system or also directly output to the circulating-air valve actuator H.

It is also conceivable within the scope of the invention to combine the evaluation and computer modules 10 described in FIG. 2 in an evaluation and computer module or to apply the evaluation and computation work to a control unit.

### REFERENCE SIGN

1—inlet valve

2—exhaust valve

3—piston

4—spark plug

5—injector nozzle

6—combustion chamber

7—cold-gas housing side

8—hot-gas housing side

9—rotor cell

10—evaluation and computer module

A—combustion engine

B—pressure-wave supercharger

C—rotor

D—control-disk

E—rotor motor

F—gas pocket valve+engine

G—control disk motor

H—circulating-air valve+motor

I—air filter

J—charge-air cooler

K—throttle valve

L—catalytic converter

M—oxidation catalytic converter

N—accelerator pedal

O—channel 1

P—channel 2

Q—channel 3

R—channel 4

S—exhaust tract

a—control disk position

b—gas pocket valve position

c—rotor speed of pressure-wave supercharger

d—circulating-air valve position

e—engine temperature

f—exhaust gas temperature

g—desired charge pressure value

h—actual charge pressure value

i—desired operating point

j—temperature of fresh air channel 1

k—rotor speed

l—actual charge air temperature value

m—desired operating point

n—actual intake air temperature value

o—engine speed

p—ambient air pressure

1-15. (canceled)

16. A method for adjusting a charge pressure of a combustion engine, wherein the charge pressure is built up by a pressure-wave supercharger to which a first channel for drawing in fresh air, a second channel for discharging compressed fresh air, a third channel for supplying exhaust gas, and a fourth channel for discharging exhaust gas are connected and which includes a cold-gas housing, to which the first and second channels are connected, a gas pocket valve arranged in an area of the third channel, and a circulating-air valve connecting the second channel to the third channel, said method comprising:
arranging a control disk for adjusting a pressure-wave process by means of a geometric offset of the third and fourth channels in relation to the first and second channels in the cold-gas housing; and
adjusting the charge pressure in at least one of four ways, a first way in dependence on a control disk position, a second way in dependence on a gas pocket valve position, a third way in dependence on a rotor speed of the pressure-wave supercharger, a fourth way in dependence on a circulating-air valve position.

17. The method of claim 16, wherein the control disk position is adjusted in dependence on at least one operating parameter selected from the group consisting of engine speed, engine temperature, actual charge-air temperature value, actual intake air temperature value, ambient air pressure, exhaust gas temperature, desired charge pressure value, actual charge pressure value, and desired operating point.

18. The method of claim 16, wherein the control disk position is adjusted in dependence on a difference of desired charge pressure value and actual charge pressure value.

19. The method of claim 16, wherein the control disk position is adjusted in dependence on at least one parameter selected from the group consisting of temperature and thermodynamic state of fresh air in the first channel, rotor speed and pressure-wave supercharger geometry.

20. The method of claim 16, further comprising controlling a scavenging air amount from the first channel to the fourth channel by adjusting the control disk position.

21. The method of claim 20, wherein the scavenging air amount from the first channel to the fourth channel is controlled during a cold start by the control disk position.

22. The method of claim 16, wherein an overflow of exhaust gas from the third channel to the second channel in a fresh gas area is prevented by the control disk position in dependence on at least one of the operating parameters selected from the group consisting of actual charge air temperature values, desired operating point, engine speed, intake air temperature, and exhaust gas temperature.

23. The method of claim 16, further comprising adjusting the gas pocket valve position in dependence on at least one of the operating parameters selected from the group consisting of engine speed, engine temperature, exhaust gas temperature, actual charge pressure value, charge pressure value, and ambient air pressure.

24. The method of claim 16, wherein a difference between desired charge pressure value and actual charge pressure value is used for adjusting the gas pocket valve position.

25. The method of claim 16, further comprising adjusting the rotor speed in dependence on at least one of engine speed and actual charge pressure value.

26. The method of claim 16, further comprising compensating load oscillations during idling of the combustion engine by adjusting at least one of the gas pocket valve position and the control disk position.

27. The method of claim 16, further comprising compensating load oscillations during idling of the combustion engine by brief shutdown of a consumer.

28. The method of claim 16, further comprising compensating load oscillations during operation of the combustion engine at substantially constant operating point by adjusting at least one of the gas pocket valve position and the control disk position.

29. The method of claim 16, further comprising compensating load oscillations during operation of the combustion engine at a substantially constant operating point by adjusting the rotor speed.

30. The method of claim 16, further comprising adjusting the circulating-air valve position in dependence on at least one of the operating parameters selected from the group consisting of actual charge pressure value, desired charge pressure value, engine temperature, exhaust gas temperature, engine speed, and desired operating point.

31. A method for adjusting a charge pressure of a combustion engine, wherein the charge pressure is built up by a pressure-wave supercharger to which a first channel for drawing in fresh air, a second channel for discharging compressed fresh air, a third channel for supplying exhaust gas, and a fourth channel for discharging exhaust gas are connected and which includes a cold-gas housing, to which the first and second channels are connected, a gas pocket valve arranged in an area of the third channel, said method comprising:
arranging a control disk for adjusting a pressure-wave process by means of a geometric offset of the third and fourth channels in relation to the first and second channels in the cold-gas housing; and
adjusting the charge pressure in at least one of three ways, a first way in dependence on a control disk position, a second way in dependence on a gas pocket valve position, a third Way in dependence on a rotor speed of the pressure-wave supercharger.

32. The method of claim 31, wherein the control disk position is adjusted in dependence on at least one operating parameter selected from the group consisting of engine speed, engine temperature, actual charge-air temperature value, actual intake air temperature value, ambient air pressure, exhaust gas temperature, desired charge pressure value, actual charge pressure value, and desired operating point.

33. The method of claim 31, wherein the control disk position is adjusted in dependence on a difference of desired charge pressure value and actual charge pressure value.

34. The method of claim 31, wherein the control disk position is adjusted in dependence on at least one parameter selected from the group consisting of temperature and thermodynamic state of fresh air in the first channel, rotor speed and pressure-wave supercharger geometry.

35. The method of claim 31, further comprising controlling a scavenging air amount from the first channel to the fourth channel by adjusting the control disk position.

36. The method of claim 35, wherein the scavenging air amount from the first channel to the fourth channel is controlled during a cold start by the control disk position.

37. The method of claim 31, wherein an overflow of exhaust gas from the third channel to the second channel in a fresh gas area is prevented by the control disk position in dependence on at least one of the operating parameters selected from the group consisting of actual charge air temperature values, desired operating point, engine speed, intake air temperature, and exhaust gas temperature.

38. The method of claim 31, further comprising adjusting the gas pocket valve position in dependence on at least one of the operating parameters selected from the group consisting of engine speed, engine temperature, exhaust gas temperature, actual charge pressure value, charge pressure value, and ambient air pressure.

39. The method of claim 31, wherein a difference between desired charge pressure value and actual charge pressure value is used for adjusting the gas pocket valve position.

40. The method of claim 31, further comprising adjusting the rotor speed in dependence on at least one of engine speed and actual charge pressure value.

41. The method of claim 31, further comprising compensating load oscillations during idling of the combustion engine by adjusting at least one of the gas pocket valve position and the control disk position.

42. The method of claim 31, further comprising compensating load oscillations during idling of the combustion engine by brief shutdown of a consumer.

43. The method of claim 31, further comprising compensating load oscillations during operation of the combustion engine at substantially constant operating point by adjusting at least one of the gas pocket valve position and the control disk position.

44. The method of claim 31, further comprising compensating load oscillations during operation of the combustion engine at a substantially constant operating point by adjusting the rotor speed.
